(19) United States
(12) Patent Application Publication
(10) Pub. No.: US 2010/0299464 A1
(43) Pub. Date: Nov. 25, 2010

(54) VEHICLE HAVING USB NETWORK

(75) Inventors: Matthew A. Cullum, Denton, TX (US); Wesley M. Mays, Coppell, TX (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: PACCAR INC, Bellevue, WA (US)

(21) Appl. No.: 12/471,139

(22) Filed: May 22, 2009

(51) Int. Cl. G06F 13/12

(52) U.S. Cl. 710/63

(57) ABSTRACT

A vehicle communication networks is provided having a plurality of communications ports provided in at least two different portions of the vehicle. These ports may be interconnected for providing communication between capable devices located in different portions of the vehicle, such as the cab and sleeper, via one or more communication protocols. Additionally, in several embodiments, the ports are “powered” for charging capable devices when plugged into one of the ports.

### BACKGROUND

Conventional Class 8 trucks typically include a chassis to which wheels are rotatably connected. Mounted on the chassis is a cabin from which an operator may drive the vehicle. For this purpose, the cabin includes various controls, such as a steering wheel, monitoring devices, such as gauges, Telematics, such as a GPS, On Star, etc, and audio/visual devices, such as a stereo, media player, etc. The vehicle may further include a sleeper compartment as part of the cab assembly for providing sleeping or resting quarters for the operator during government mandated rest periods. The sleeper compartment may include amenities such as a TV and a console for speakers, a clock, temperature controls, and lights to comfort the operator during these rest periods.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Aspects of the present disclosure provide a vehicle, such as the Class 8 truck described above, with a communication network, such as a serial bus network (e.g., universal serial bus (USB), Firewire (IEEE 1934), so that the operator can access data from multiple locations in the cab assembly. The network may comprise at least two interconnected ports located in separate sections of the cab assembly, such as the main cabin and the sleeper compartment. In one embodiment, one or more of the ports may be “powered” so as to provide charging capabilities to connected devices.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a side schematic view of one representative vehicle incorporating a communication network formed in accordance with aspects of the present invention; and

FIG. 2 is a block diagram of one exemplary communication network formed in accordance with aspects of the present invention.

### DETAILED DESCRIPTION

Embodiments of the present invention will now be described with reference to the accompanying drawings where like numerals correspond to like elements. Embodiments of the present invention are directed to vehicle communication networks having a plurality of communications ports provided in at least two different portions of the vehicle. These ports may be interconnected for providing communication between capable devices located in different portions of the vehicle, such as the main cabin and sleeper compartment, via one or more communication protocols. Additionally, in several embodiments, the ports are “powered” for charging capable devices when plugged into one of the ports.

While embodiments of the vehicle network will be described with reference to their installation in heavy trucks, it will be appreciated that aspects of the present invention have wide application, and therefore, may be suitable for use in other vehicles, such as cars and lightweight trucks, or vehicles having main living quarters, such as boats, recreational vehicles, etc. Accordingly, the following descriptions and illustrations herein should be considered illustrative in nature, and thus, not limiting the scope of the present invention, as claimed.

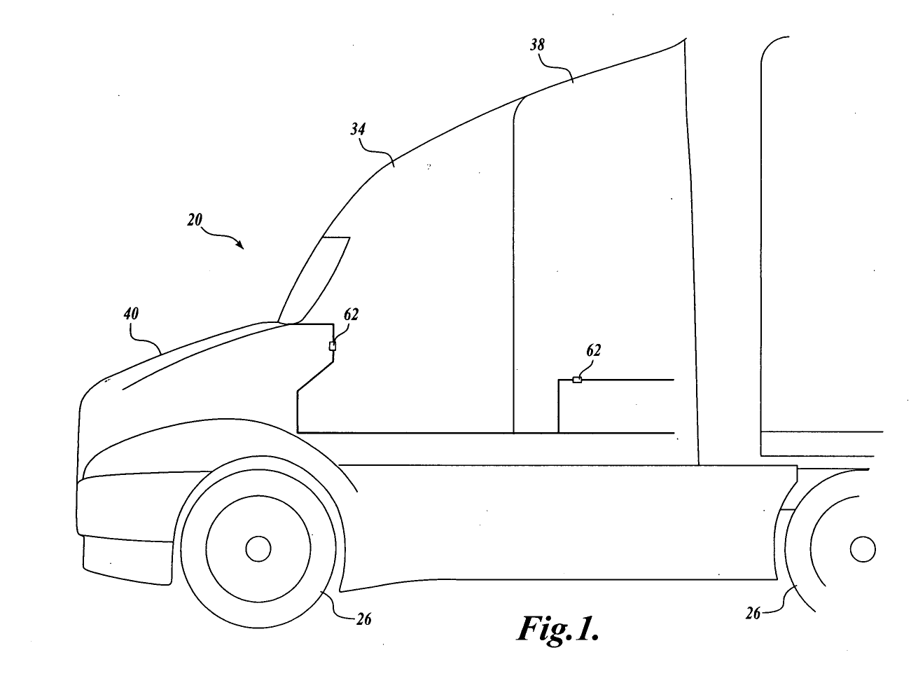

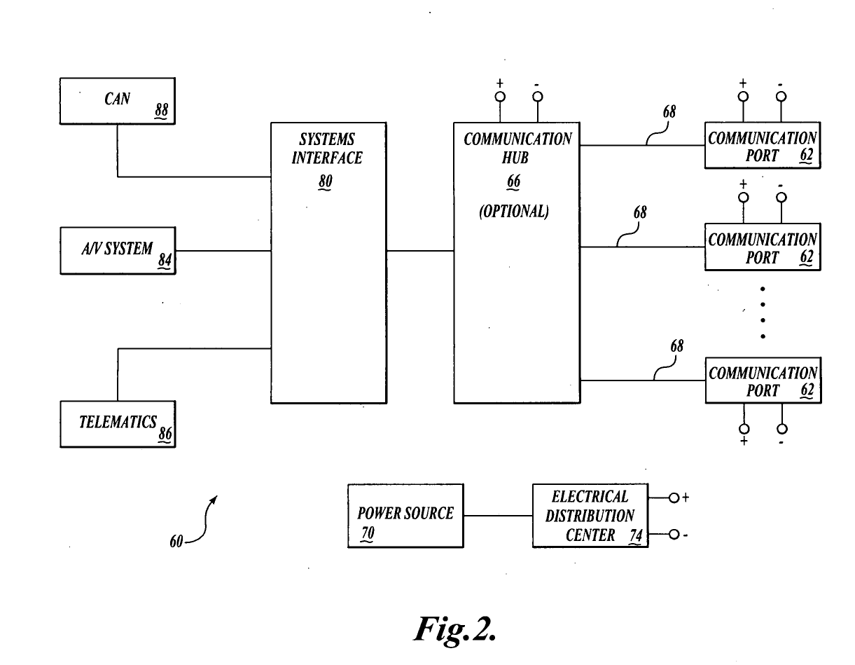

Turning now to FIG. 1, there is shown one exemplary vehicle in the form of a Class 8 tractor, generally designated 20, incorporating one embodiment of a communication network 60 (See FIG. 2). The network 60 or any combination of components hereinafter described may be installed on new vehicles, such as tractor 20, or may be retrofitted on existing vehicles, such as tractor 20.

As best shown in FIG. 1, the tractor 20 comprises a chassis that is supported by wheels 26 connected thereto via conventional suspension assemblies (not shown). A conventional cab assembly 30 is supportably mounted on the chassis. The cab assembly 30 includes a front end 40 that generally houses an internal combustion engine that propels the tractor. The cab assembly 30 also includes a main cabin 34 that generally houses the vehicle seats, a steering wheel and other operator control inputs (not shown for ease of illustration), such as a clutch pedal (in some manual systems), an ignition or power switch, an accelerator pedal, a service brake pedal, and a parking brake for controlling the operation of the vehicle. The main cabin 34 of the vehicle 20 may also include a control console, which may include a stereo, one or more displays, a navigation device, and various gages, lights, switches, and the like. The cab assembly 30 may further include a sleeper compartment 38 located behind the main cabin 182 where the operator may sleep, watch TV, listen to music, read, work, etc, during government mandated rest periods.

Referring now to FIG. 2, the communication network 60 will now be described in more detail. FIG. 2 is a block diagram of one embodiment of the communication network 60 formed in accordance with aspects of the present invention. The network 60 includes a plurality of communication ports 62 communicatively interconnected via a communication hub 66 and communication cables 68. In the embodiment shown in FIG. 1, at least one of the ports 62 is located in the main cabin of the tractor, such as on the control console, and at least one of the ports is located in the sleeper compartment of the tractor 20, such as in proximity to other sleeper compartment amenities, such as lights, a clock, etc. The ports can be configured to operate under any communication protocol for transferring data between attached devices. In one embodiment, the ports are serial bus ports, such as USB, FireWire, or any other current or future developed serial bus ports. It will be appreciated that the serial ports may operate under any current or future developed USB or FireWire protocol.

In one embodiment, the ports 62 may be configured to provide battery charging capabilities to battery powered devices, such as portable flash memory music payers, cellular phones, PDA's, etc. when plugged into one of the ports. To that end, one or more of the ports 62 may “powered ports”, and as such, are electrically connected to a power source 70 for receiving power therefrom. In the embodiment shown in FIG. 2, the power source 70 is one or more batteries, such as the vehicle starter battery or auxiliary power unit, that distributes power to the ports 62 via an electrical distribution center 74. Alternatively, the hub 64 may be electrically coupled to the electrical distribution center 74 for receiving power from the power source 70. In this embodiment, the ports 62 receive power for charging, etc. from the hub 64 through the communication cables 68.

The network 60 may further include a vehicle systems interface 80 for communicating with one or more systems of the vehicle. For example, the interface 80 may be configured for communication with an entertainment or A/V system 84 (e.g., stereo, CD player, DVD player, game console, etc.), a Telematics system 86 (e.g., GPS, weather service, satellite, cellular, etc.), and/or the vehicle area network (CAN) 88. As such, the operator while positioned in the sleeper compartment with an appropriate electronics device attached to the port 62 located thereat may access music from the stereo, navigation information, the weather at the vehicle's current future location, and/or vehicle operating data (e.g., battery levels, fuel levels, odometer readings, etc.). While the systems interface 80 is shown in FIG. 2 as a separate device from the network hub 64, it will be appreciated that the functionality of the network hub 64 and the systems interface 80 may be carried out in a single device.

While illustrative embodiments have been illustrated and described, it will be appreciated that various changes can be made therein without departing from the spirit and scope of the invention, as claimed.

The embodiments of the invention in which an exclusive property or privilege is claimed are defined as follows:

1. A vehicle having a cab section and a sleeper section, comprising:
(a) a power supply; and
(b) an electrical distribution circuit in communication with the power supply for receiving power therefrom;
(c) a vehicle network, comprising:
(i) a first serial bus connector installed in the cab section of the vehicle;
(ii) a second serial bus connector installed in the sleeper section of the vehicle and coupled to the first serial bus connector via a communication link;
wherein the first and/or second serial bus connector receives power from the electrical distribution circuit.

2. The vehicle of claim 1, wherein the serial bus connector is a Universal Serial Bus (USB) connector or a IEEE 1394 connector.

3. The vehicle of claim 1, further comprising a hub connected in communication with the first and second serial bus connectors.

4. The vehicle of claim 3, further comprising an interface that is adapted to connect the hub with one or more vehicle systems.

5. The vehicle of claim 3, wherein the hub is electrically connected to the electrical distribution circuit, the hub transmitting power from the hub to the first and/or second serial bus connectors.

6. The vehicle of claim 1, wherein the first and/or second serial bus connector is coupled directly to the electrical distribution circuit for receiving power therefrom.

7. A tractor having a cab section and a sleeper section, comprising:
(a) a power supply; and
(b) a vehicle network, comprising:
(i) a first universal serial bus connector installed in the cab section of the vehicle;
(ii) a second universal serial bus connector installed in the sleeper section of the vehicle;
(iii) a communication link interconnecting the first and second universal serial bus connectors;
wherein the first and/or second universal serial bus connector receives power from the power supply
The vehicle of claim 1, wherein the serial bus connector is a Universal Serial Bus (USB) connector or a IEEE 1394 connector.

8. The vehicle of claim 7, further comprising a hub interconnect between the first and second serial bus connectors.

9. The vehicle of claim 7, further comprising an interface that is adapted to connect the hub with one or more vehicle systems.

10. The vehicle of claim 8, wherein the hub is electrically connected to the power supply, the hub transmitting power from the hub to the first and/or second serial bus connectors via the communication link.
